(19) United States
(12) Patent Application Publication
(10) Pub. No.: US 2024/0300594 A1
(43) Pub. Date: Sep. 12, 2024

(54) BOTTOM ELEMENT OF A MOTOR VEHICLE TRUNK

(71) Applicant: PSA AUTOMOBILES SA, Poissy (FR)

(72) Inventors: Pascal BERNARDINO, VILLIERS SUR MARNE (FR); Frederic LORETTE, VOISINS LE BRETONNEUX (FR); Laurent RIVIERRE, PARIS (FR)

(21) Appl. No.: 18/264,696

(22) PCT Filed: Jan. 20, 2022
(86) PCT No.: PCT/FR2022/050107

§ 371 Date: Aug. 8, 2023

(30) Foreign Application Priority Data
Feb. 19, 2021 (FR) 2101642

(51) Int. Cl. B62D 43/10; B62D 25/08

(52) U.S. Cl. CPC B62D 43/10; B62D 25/087

(57) ABSTRACT

The invention relates to a trunk bottom element (6). The trunk bottom element (6) according to the invention includes an external frame (11) laterally and longitudinally delimiting the trunk bottom element (6), a central opening (8) delimited by a cylindrical wall (12) and an angular indexing member (9) configured to enable angular indexing of a closure cap of the central opening (8), with respect to the vertical direction of the trunk bottom element (6). In the trunk bottom element (6) according to the invention, the external frame (11) has, in a vertical direction, an upper bearing surface (16) intended to receive a trunk floor element. The central opening (8) of the trunk bottom element (6) is configured to alternately house a spare wheel of the motor vehicle of the “donut” type and of the “full-size” type.

### CROSS-REFERENCE TO RELATED APPLICATIONS

This application is the US National Stage under 35 USC § 371 of International Application No. PCT/FR2022/050107, filed Jan. 20, 2022, which claims the priority of the French application 2101642 filed on Feb. 19, 2021, the content (text, drawings and claims) of both said applications being incorporated by reference herein.

### BACKGROUND

The technical context of the present description relates to motor vehicle trunk packing and in particular trunk bottom arrangements intended to support a removable carpet of a motor vehicle trunk. More particularly, a motor vehicle trunk bottom element is described.

In the prior art, motor vehicle trunk arrangements are known comprising a trunk bottom element forming a sub-carpet storage, closed by a closure cap. These trunk bottom arrangements are intended to support a removable carpet of a motor vehicle trunk. In other words, these trunk bottom arrangements are intended to form a vertical counter-support supporting the removable carpet of a motor vehicle trunk.

One drawback of these trunk bottom arrangements is that they lack a uniform slope guaranteeing an optimal vertical counter-support. Indeed, should the closure cap of the trunk bottom element be poorly oriented, the slope is then non-homogeneous. When the trunk bottom element and the closure cap form a vertical counter-support which is not optimal, the removable carpet of a motor vehicle trunk is then poorly positioned. This is detrimental to the volume of the trunk and disturbs the positioning of the objects accommodated in the trunk of the motor vehicle equipped with said trunk arrangement.

Moreover, motor vehicle trunk bottom arrangements are also known that have trunk bottom elements specifically configured according to the use that will be made thereof and according to the type of motor vehicle that they equip. The closure caps that are associated therewith are also specific. Motor vehicle trunk bottom elements are known that are designed to house a spare wheel of the “donut” type, which is smaller than the other wheels equipping the motor vehicle. Alternatively, motor vehicle trunk bottom elements are known that are designed to house a spare wheel of the “full-size” type, similar to the other wheels of the motor vehicle. Still alternatively, motor vehicle trunk bottom elements are known that are designed to house an audio system.

The drawback of these motor vehicle trunk bottom arrangements is that they require different types of trunk bottom elements, each adapted to the object that it is intended to house, and cooperating with a type of closure cap specific to the considered trunk bottom element. Also, these motor vehicle trunk bottom arrangements require as many assembly chains as variants, which multiplies the number of parts to be manufactured. Such motor vehicle trunk arrangements are economically disadvantageous.

### SUMMARY

The devices described herein aim to provide a new motor vehicle trunk bottom element in order to address at least some of the preceding problems and to further lead to other advantages.

Another aim is to provide a motor vehicle trunk bottom element that is simple both in terms of implementation thereof, and in terms of manufacture thereof.

Another aim is to provide a motor vehicle trunk bottom element that is universal and configured to adapt to different motor vehicles.

Another aim is to provide a motor vehicle trunk bottom element configured to guarantee the support, under load, of a removable carpet of a motor vehicle trunk.

Another aim is to provide a motor vehicle trunk bottom element that is compatible with the operation of an audio system.

According to a first aspect, at least one of the aforementioned objectives is achieved with a motor vehicle trunk bottom element, the trunk bottom element including (i) an external frame delimiting laterally and longitudinally the trunk bottom element, the external frame having in a vertical direction an upper bearing surface intended to receive a trunk floor element, and (ii) a central opening delimited by a cylindrical wall, the central opening being configured to house therein a spare wheel of the motor vehicle, characterized in that the trunk bottom element includes an angular indexing member configured to enable angular indexing of a closure cap of the central opening, with respect to the vertical direction of the trunk bottom element.

In the trunk bottom element, the external frame delimits the trunk bottom element, laterally and longitudinally. In the trunk bottom element, a longitudinal direction should be understood as a direction intended to extend from the front to the rear in the motor vehicle equipped with said trunk bottom element. A lateral direction extends from the left to the right in the motor vehicle equipped with said trunk bottom element. In the trunk bottom element, the lateral direction extends substantially perpendicular to the longitudinal direction.

In the trunk bottom element, the vertical direction corresponds to a direction from the bottom to the top. It should be understood that the upper bearing surface of the external frame of the trunk bottom element is intended to be oriented upward of said trunk bottom element.

The external frame is a structural element of the trunk bottom element. The upper bearing surface of the external frame is intended to support a trunk floor element of the motor vehicle equipped with the trunk bottom element. The upper bearing surface of the external frame is configured to guarantee a load resistance of said trunk floor element. For example, the trunk floor element is a removable carpet of a motor vehicle trunk.

In the trunk bottom element, the central opening delimited by the cylindrical wall is substantially centered in the lateral direction and in the longitudinal direction with respect to the external frame of the trunk bottom element.

In the trunk bottom element, the cylindrical opening is intended to house a spare wheel of the motor vehicle that it equips. It should be understood that the cylindrical opening is adapted to house a spare wheel of the “donut” type, which is smaller than other wheels equipping the motor vehicle, or alternatively a spare wheel of the “full-size” type, which is similar to the other wheels of the motor vehicle. Such a trunk bottom element is standard for different types of spare wheels, which allows for scale savings in a manufacturing line of a motor vehicle equipped with such a trunk bottom element.

The angular indexing member is configured to enable angular indexing of a closure cap of the central opening, with respect to the vertical direction of the trunk bottom element. The angular indexing member is configured to authorize one single and unique angular configuration of assembly of the closure cap on the trunk bottom element. The indexing member is intended to cooperate with an angular indexing device of the closure cap by complementary shape engagement.

Thus, the angular indexing member is intended to guarantee a unique relative position between the trunk bottom element and the closure cap of the central opening. The angular indexing member indexing the trunk bottom element and the closure cap of the central opening with respect to each other also allows relative alignment of the two parts to be kept. A unique relative position between the trunk bottom element and the closure cap of the central opening is essential to uniformly support the trunk floor element.

Indeed, the trunk bottom element is configured to ensure a homogeneous slope and therefore an optimal vertical counter-support in the motor vehicle trunk that it equips. The entire upper bearing surface of the external frame of the trunk bottom element then supports the trunk floor element, thereby reinforcing its robustness. The user perceived quality is improved compared to existing trunk elements.

Thus, the described device in accordance with its first aspect advantageously allows a load resistance of the trunk floor element to be guaranteed. It also enables a user to facilitate the relative positioning of the closure cap with respect to the trunk bottom element by the stress imposed by the angular indexing member.

Advantageously, the motor vehicle trunk bottom element in accordance with the first aspect comprises at least one of the improvements hereinbelow; the technical features forming these improvements could be considered separately or in combination:
the angular indexing member is located at the upper bearing surface of the external frame of the trunk bottom element;
according to a first variant, the angular indexing member is in the form of a notch formed on the cylindrical wall. The notch forming the indexing member corresponds to a cutout of the cylindrical wall of the trunk bottom element in accordance with the first aspect. It is possible to generalize to a female portion formed on the cylindrical wall of the trunk bottom element, intended to cooperate by complementary shape engagement with a male portion formed on the closure cap. According to a second variant, alternative or complementary to the first alternative embodiment, the angular indexing member is the form of a groove formed on an internal face of the cylindrical wall. The groove forming the indexing member corresponds to a long and narrow hollow notch formed in the cylindrical wall of the trunk bottom element in accordance with the first aspect. According to a third variant, alternative or complementary to the first alternative embodiment and/or to the second alternative embodiment, the angular indexing member is the form of a rib formed on an internal face of the cylindrical wall. For example, the rib forming the indexing member is in the form of a cylindrical or prismatic support. It is possible to generalize to a male portion projecting from the trunk bottom element, intended to cooperate by complementary shape engagement with a female portion formed on the closure cap;
at the angular indexing member, the cylindrical wall is located radially at a distance from the external frame, with respect to the vertical direction, so that the trunk bottom element includes a recess peripheral to the central opening delimited radially by the cylindrical wall and by the external frame. Such a peripheral recess allows the amount of material necessary for the manufacture of the trunk bottom element in accordance with the first aspect to be reduced. Advantageously, the peripheral recess allows small objects to be housed under the floor element. Advantageously, the cylindrical wall is entirely located radially at a distance from the external frame, with respect to the vertical direction, the peripheral recess extending all around the cylindrical wall;
an upper end of the cylindrical wall is coplanar or substantially coplanar with the upper bearing surface. Preferably, the upper end of the cylindrical wall is coplanar with the upper bearing surface of the external frame, so as to form only one bearing surface. By being coplanar, the upper support surface of the external frame of the trunk bottom element and the upper end of the cylindrical wall of the trunk bottom element are intended to receive the trunk floor element;
the trunk bottom element includes a housing intended to house an audio system, the housing being formed between a lower face of the trunk bottom element and the upper bearing surface, the housing being delimited in the vertical direction by a membrane. In the trunk bottom element in accordance with the first aspect, the lower face is located opposite to the upper bearing surface, with respect to the vertical direction. Such a trunk bottom element is configured to allow alternately an audio system to be housed or a spare wheel of the motor vehicle of the “donut” type or a spare wheel of the motor vehicle of the “full-size” type to be housed in the central opening. Such a trunk bottom element allows for a new economy of scale in a manufacturing line of a motor vehicle equipped with such a trunk bottom element;
the housing is in the form of an opening passing through the trunk bottom element according to the lateral direction.
in the vertical direction, the membrane is located in an intermediate position between the upper bearing surface and the lower face of the trunk bottom element. Such a membrane offers a resonance space to the audio system;
in the vertical direction, the membrane is located at a height comprised between 30% and 70% of a height of the trunk bottom element considered in the vertical direction and at the level of the housing. Such a membrane allows the rigidity of the trunk bottom element to be improved. In particular, such a membrane allows the rigidity of the cylindrical wall of the trunk bottom element to be improved by conferring better radial strength on said cylindrical wall;
in the longitudinal direction, the upper bearing surface forms a non-zero angle with respect to a horizontal plane. Horizontal plane should be understood to mean a plane extending from the front to the rear and perpendicular to a vertical direction extending from the bottom to the top;
the trunk bottom element is made of a light material, such as for example a polystyrene or an expanded polystyrene;
the trunk bottom element is preferably obtained by molding. This industrial forming method also allows a large number of identical trunk bottom element units to be obtained at a lower cost, by repeatedly using the same mold.

According to a second aspect, a trunk arrangement for a motor vehicle is proposed, the trunk arrangement including (i) a trunk bottom element in accordance with the first aspect or according to any one of its improvements, and (ii) a closure cap housed in the central opening of the trunk bottom element, the closure cap including an angular indexing device cooperating with the angular indexing member of the trunk bottom element by complementary shape cooperation.

In the trunk arrangement in accordance with the second aspect, the closure cap is intended to close the central opening of the trunk bottom element.

In the trunk arrangement in accordance with the second aspect, the indexing member of the trunk bottom element cooperates with the angular indexing device of the closure cap by complementary shape engagement. The indexing member of the trunk bottom element is fastened to the angular indexing device of the closure cap by complementary shape engagement between a male portion and a female portion. In a first embodiment, the indexing member of the trunk bottom element forms the male portion and the angular indexing device of the closure cap forms the female portion. In a second alternative embodiment of the first embodiment, the indexing member of the trunk bottom element forms the female portion and the angular indexing device of the closure cap forms the male portion.

Cooperation between the indexing member of the trunk bottom element and the angular indexing device of the closure cap guarantees a unique relative position between the trunk bottom element and the closure cap. A unique relative position between the trunk bottom element and the closure cap is essential to optimally support the trunk floor element.

Indeed, such a trunk arrangement ensures a homogeneous slope when the closure cap closes the central opening of the trunk bottom element. The trunk arrangement in accordance with the second aspect offers an optimal vertical counter-support in the motor vehicle trunk that it equips. The entire upper bearing surface of the external frame of the trunk bottom element then supports the trunk floor element, thereby reinforcing its robustness. The quality perceived by the user is improved compared to the trunk arrangements in accordance with the second aspect.

Thus, the described device in accordance with its second aspect advantageously allows a load resistance of the trunk arrangement to be guaranteed.

The trunk arrangement for a motor vehicle in accordance with the second aspect advantageously comprises at least one of the improvements hereinbelow; the technical features forming these improvements could be considered separately or in combination:
the closure cap has a general cylindrical conformation with shape and dimension complementary to those of the central opening of the trunk bottom element, the angular indexing device including a prismatic support which projects radially with respect to the general cylindrical conformation. Such a closure cap allows the entire central opening of the trunk bottom element to be closed. The projecting prismatic support forms a male portion intended to cooperate with the indexing member of the trunk bottom element forming a complementary female portion. The prismatic support projects radially in a direction perpendicular with respect to a vertical direction of the closure cap, and radial with respect to the cylindrical/circular shape of the general conformation of the closure cap;
when the angular indexing member of the trunk bottom element is in the form of a notch formed on the cylindrical wall, the prismatic support includes a groove configured to enable engagement of the notch of the trunk bottom element. The groove of the prismatic support of the angular indexing device of the closure cap, engaged in the notch of the trunk bottom element, reinforces the closure cap being held in a unique angular position with respect to the trunk bottom element.

According to a third aspect, a motor vehicle is proposed including a trunk arrangement in accordance with the second aspect or according to any one of its improvements.

In the motor vehicle in accordance with the third aspect, the closure cap of the trunk arrangement is intended to close the central opening of the trunk bottom element.

In the motor vehicle in accordance with the third aspect, the indexing member of the trunk bottom element cooperates with the angular indexing device of the closure cap of the trunk arrangement by complementary shape engagement. The indexing member of the trunk bottom element is fastened to the angular indexing device of the closure cap of the trunk arrangement by complementary shape engagement between a male portion and a female portion. In a first example embodiment, the indexing member of the trunk bottom element forms the male portion and the angular indexing device of the closure cap of the trunk arrangement forms the female portion. In a second alternative embodiment of the first embodiment, the indexing member of the trunk bottom element forms the female portion and the angular indexing device of the closure cap of the trunk arrangement forms the male portion.

In the motor vehicle in accordance with the third aspect, cooperation between the indexing member of the trunk bottom element and the angular indexing device of the closure cap of the trunk arrangement guarantees a unique relative position between the trunk bottom element and the closure cap. A unique relative position between the trunk bottom element and the closure cap is essential to optimally support a trunk floor element of the motor vehicle in accordance with the third aspect.

In the motor vehicle according to the third aspect, a homogeneous slope is formed when the closure cap of the trunk arrangement closes the central opening of the trunk bottom element. In the motor vehicle in accordance with the third aspect, the homogeneous slope thus formed offers an optimal vertical counter-support in the trunk of said motor vehicle. The entire upper bearing surface of the external frame of the trunk bottom element then supports the trunk floor element of the motor vehicle in accordance with the third aspect, thereby guaranteeing a load resistance of the trunk arrangement in the motor vehicle in accordance with the third aspect.

Various embodiments are provided, integrating according to all possible combinations thereof the different optional features disclosed herein.

### BRIEF DESCRIPTION OF THE FIGURES

Other features and advantages will become more apparent through the following description, and several embodiments given for indicative and non-limiting purposes with reference to the appended schematic drawings, wherein:

FIG. 1 shows a schematic view of a motor vehicle in accordance with the third aspect.

FIG. 2 shows a schematic view of a trunk bottom element in accordance with the first aspect, seen from above.

FIG. 3 shows a schematic view of the trunk bottom element in accordance with the first aspect illustrated in FIG. 2, seen from the bottom.

FIG. 4 shows a sectional view of the trunk bottom element in accordance with the first aspect illustrated in FIG. 2.

FIG. 5 shows a schematic view of a trunk arrangement in accordance with the second aspect, seen from above in isometric perspective, in a first embodiment.

FIG. 6 shows a schematic view of a closure cap of the trunk arrangement in accordance with the second aspect illustrated in FIG. 5, seen from above.

FIG. 7 shows a schematic sectional view of the trunk arrangement in accordance with the second aspect illustrated in FIG. 5, implemented in the motor vehicle in accordance with the third aspect, in a first situation.

FIG. 8 shows a schematic view of the trunk arrangement in accordance with the second aspect illustrated in FIG. 5, implemented in the motor vehicle in accordance with the third aspect, in a second situation.

FIG. 9 shows a cross-section of the trunk arrangement in accordance with the second aspect illustrated in FIG. 8.

FIG. 10 shows a schematic view of a trunk arrangement in accordance with the second aspect, seen from above in isometric perspective, in a second embodiment.

FIG. 11 shows a schematic view of a closure cap of the trunk arrangement in accordance with the second aspect illustrated in FIG. 10, seen from above.

FIG. 12 shows a schematic sectional view of the trunk arrangement in accordance with the second aspect illustrated in FIG. 10, implemented in the motor vehicle in accordance with the third aspect.

FIG. 13 shows a schematic view of a trunk arrangement in accordance with the second aspect, seen from above in isometric perspective, in a third embodiment[.

FIG. 14 shows a schematic view of a closure cap of the trunk arrangement in accordance with the second aspect illustrated in FIG. 13, seen from above.

FIG. 15 shows a cross-sectional view of the trunk arrangement in accordance with the second aspect illustrated in FIG. 13, implemented in the motor vehicle in accordance with the third aspect.

Of course, the features, the variants and the different embodiments could be associated together, according to various combinations, to the extent that they are not incompatible or exclusive of one another. In particular, it is possible to imagine variants comprising only a selection of features described hereinafter in isolation from the other described features, if this selection of features is sufficient to confer a technical advantage or to differentiate the described devices from the prior art.

In particular, all of the described variants and embodiments could be combined together if nothing technically opposes this combination.

In the figures, the elements common to several figures keep the same reference.

### DETAILED DESCRIPTION

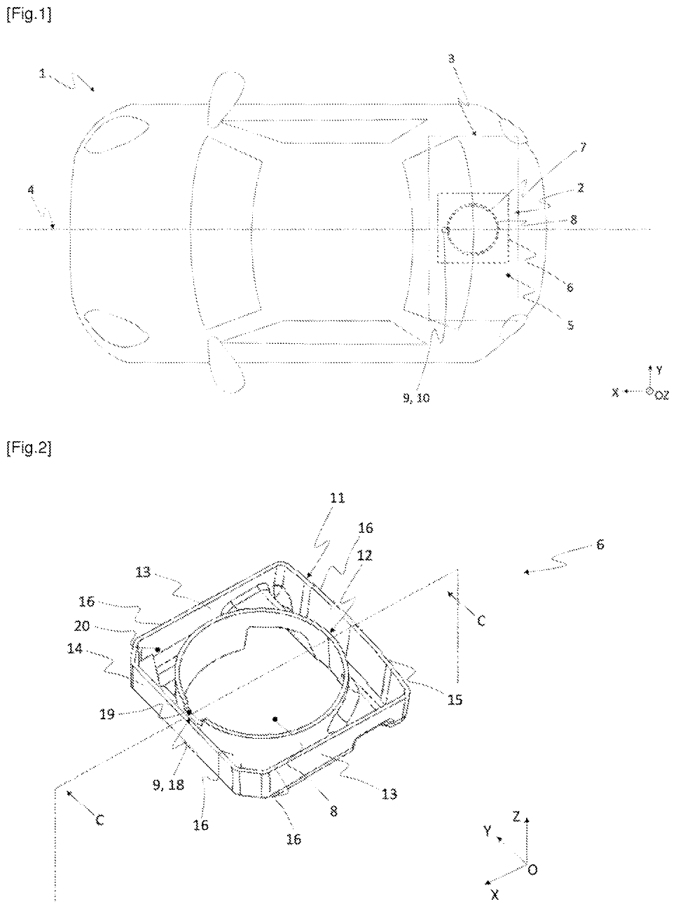

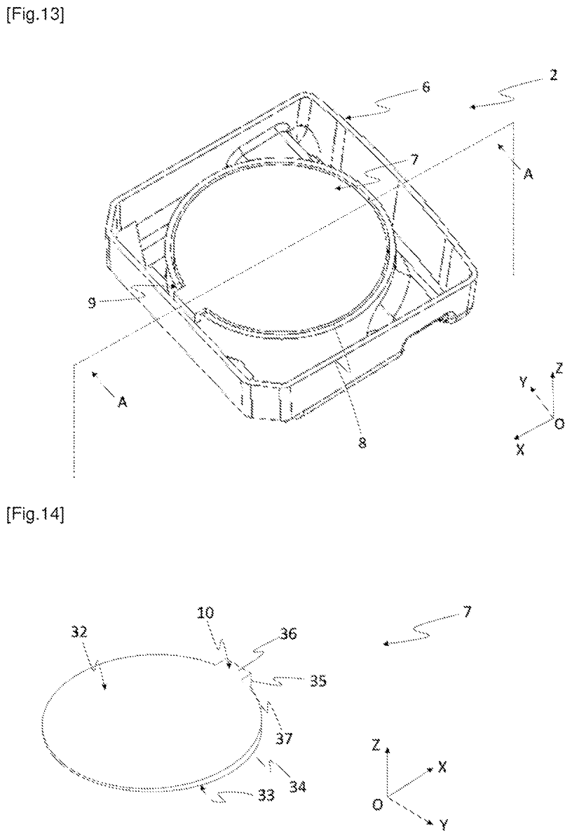

In FIGS. 1 to 15, the orientations and directions are defined as follows. A longitudinal direction, corresponding to a direction from the rear to the front, will be represented by an axis OX. A lateral direction corresponding to a direction from the left to the right will be represented by an axis OY. A vertical direction, corresponding to a direction from the bottom to the top, will be represented by an axis OZ. These different axes define an orthonormal coordinate system OXYZ shown in the various figures. In the orthonormal reference frame, the “front” orientation will be defined by the positive direction of the axis OX, the “rear” orientation being defined by the negative direction of this same axis. The “top” or “upper” orientation will be defined by the positive direction of the axis OZ, the “below” or “lower” orientation being defined by the negative direction of this same axis.

FIG. 1 shows a motor vehicle 1 in accordance with the third aspect. The motor vehicle 1 in accordance with the third aspect includes a trunk 3 arrangement 2 in accordance with the second aspect.

In the motor vehicle 1 in accordance with the third aspect shown in FIG. 1, the trunk 3 arrangement 2 is centered with respect to a longitudinal median axis 4 of the motor vehicle 1, the median longitudinal axis 4 extending along the axis OX. In the motor vehicle 1 in accordance with the third aspect, the trunk 3 arrangement 2 supports a trunk 3 floor element 5.

FIG. 1 shows that the trunk 3 arrangement 2 in accordance with the second aspect includes a trunk 3 bottom element 6 in accordance with the first aspect and a closure cap 7 housed in a central opening 8 of the trunk 3 bottom element 6. The closure cap 7, which has a generally cylindrical conformation with shape and dimension complementary to those of the central opening 8 of the trunk 3 bottom element 6, completely closes the central opening 8 of the trunk 3 bottom element 6 in FIG. 1.

FIG. 1 shows that, in the trunk 3 arrangement 2 in accordance with the second aspect, the trunk 3 bottom element 6 in accordance with the first aspect comprises an angular indexing member 9. In the trunk 3 arrangement 2, the closure cap 7 includes an angular indexing device 10. The angular indexing device 10 of the closure cap 7 is formed at the front of the closure cap 7. The angular indexing device 10 of the closure cap 7 is formed at the rear of the angular indexing member 9 of the trunk 3 bottom element 6. In the motor vehicle 1 in accordance with the third aspect, the angular indexing device 10 of the closure cap 7 and the angular indexing member 9 of the trunk 3 bottom element 6 are centered on the median longitudinal axis of the motor vehicle 1.

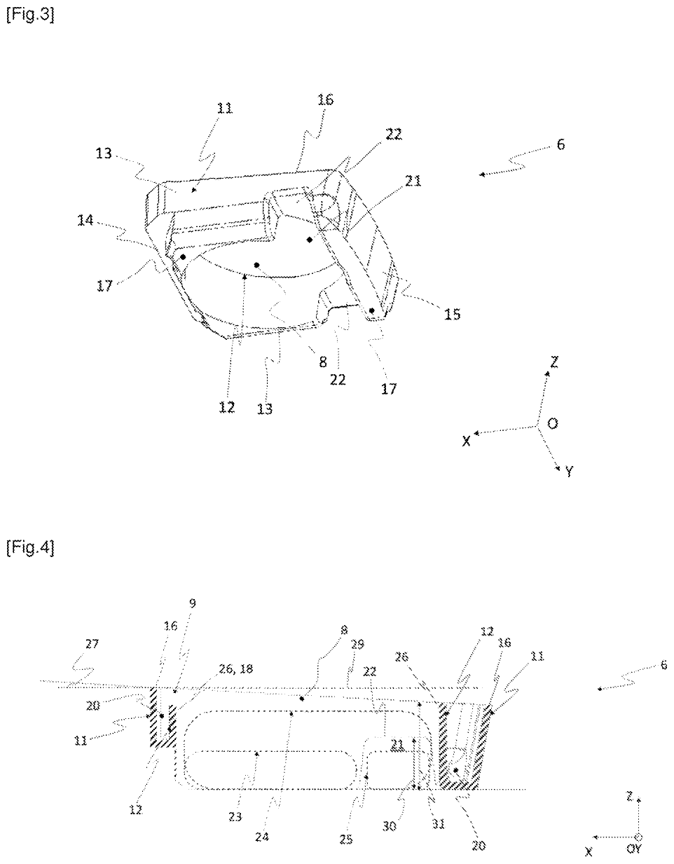

Referring to FIGS. 2, 3 and 4, the trunk 3 bottom element 6 in accordance with the first aspect is illustrated. The trunk 3 bottom element 6 is seen from above in FIG. 2, seen from below in FIG. 3 and seen in FIG. 4 according to a longitudinal section CC shown in FIG. 2.

FIGS. 2, 3 and 4 show that the trunk 3 bottom element 6 in accordance with the first aspect includes an external frame 11, the central opening 8 and the angular indexing member 9, the angular indexing member 9 being visible in FIGS. 2 and 4. The central opening 8 is delimited by a cylindrical wall 12 of the trunk 3 bottom element 6.

FIGS. 2 and 3 show that the external frame 11 of the trunk 3 bottom element 6 comprises two side walls 13, each connecting a front wall 14 of the external frame 11 to a rear wall 15 of the external frame 11. The lateral walls 13 of the external frame 11 laterally delimit the trunk 3 bottom element 6. The front wall 14 of the external frame 11 and the rear wall 15 of the external frame 11 longitudinally delimit the trunk 3 bottom element 6.

FIG. 2 shows that the external frame 11 of the trunk 3 bottom element 6 has an upper bearing surface 16 intended to receive the trunk 3 floor element 5. The upper support surface 16 of the external frame 11 of the trunk 3 bottom element 6 extends at the two side walls 13, the front wall 14 and the rear wall 15 of the external frame 11. The upper support surface 16 of the external frame 11 of the trunk 3 bottom element 6 is opposite to a lower face 17 of the trunk 3 bottom element 6, with respect to the vertical direction, oriented according to the axis OZ. The lower face 17 of the trunk 3 bottom element 6 is visible in FIG. 3 and not in FIG. 2, due to the viewing angle.

FIG. 2 shows that the angular indexing member 9 of the trunk 3 bottom element 6 is in the form of a notch 18 formed on the cylindrical wall 12 of the trunk 3 bottom element 6 at the front of the trunk 3 bottom element 6. The notch 18 comprises an engagement face 19 intended to cooperate with the angular indexing device 10 of the closure cap 7. The engagement face 19 of the notch 18 forming the angular indexing member 9 of the trunk 3 bottom element 6 extends substantially parallel, and set back in the vertical direction, from the upper bearing surface 16 of the external frame 11 of the trunk 3 bottom element 6.

FIG. 2 shows the trunk 3 bottom element 6 in accordance with the first aspect comprising a peripheral recess 20 extending all around the cylindrical wall 12. The peripheral recess 20 is radially delimited by the cylindrical wall 12 and by the external frame 11 of the trunk 3 bottom element 6. FIG. 4 shows in particular that, at the angular indexing member 9 of the trunk 3 bottom element 6, the cylindrical wall 12 is located radially away from the external frame 11, with respect to the vertical direction oriented according to the axis OZ.

FIG. 3 shows that the trunk 3 bottom element 6 in accordance with the first aspect comprises a housing 21 intended to house an audio system, herein not shown. The housing 21 intended to house an audio system is formed between the lower face 17 of the trunk 3 bottom element 6 and the upper bearing surface 16 of the external frame 11 of the trunk 3 bottom element 6. The housing 21 intended to house an audio system is delimited in the vertical direction, oriented according to the axis OZ, by a membrane 22. The membrane 22 is made integrally in one piece with the trunk 3 bottom element 6 in accordance with the first aspect. The membrane 22 extends between the cylindrical wall 12 of the trunk 3 bottom element 6 and the external frame 11 of the trunk 3 bottom element 6, on either side of said cylindrical wall 12. The housing 21 intended to house an audio system is in the form of an opening passing through the trunk 3 bottom element 6 in the lateral direction, oriented according to the axis OY. The housing 21 intended to house an audio system extends from one of the two side walls 13 to the other one of the two side walls 13. The housing 21 and the central opening 8 of the trunk 3 bottom element 6 overlap and together form a continuous volume.

FIG. 4 illustrates, in dotted lines, different parts 23, 24, 25 that can be housed alternately in the trunk 3 bottom element 6 in accordance with the first aspect. It should be understood that the trunk 3 bottom element 6 can house a spare wheel 23 of the motor vehicle 1 of the “donut” type in the central opening 8 or a spare wheel 24 of the motor vehicle 1 of the “full-size” type in the central opening 8, or an audio system 25 in the housing 21. Thus, the same trunk 3 bottom element 6 allows different options to be offered for housing a spare wheel 23 of the motor vehicle 1 of the “donut” type 23 or a spare wheel 24 of the motor vehicle 1 of the “full-size” type or an audio system 25, or none of these parts 23, 24, 25. Regardless of the selected configuration, the trunk 3 bottom element 6 in accordance with the first aspect is universal and allows different motor vehicles 1 in accordance with the third aspect to be equipped without distinction.

FIG. 4 shows that the cylindrical wall 12 of the trunk 3 bottom element 6 comprises an upper end 26. The upper end 26 of the cylindrical wall 12, considered at the rear of the trunk 3 bottom element 6, is coplanar with the upper bearing surface 16 of the external frame 11 of the trunk 3 bottom element 6 so as to form only one bearing surface. In the longitudinal direction, oriented according to the axis OX, the upper bearing surface 16 forms a non-zero angle 27 with respect to a horizontal plane 29 perpendicular to the axis OZ. The upper end 26 of the cylindrical wall 12, considered at the front of the trunk 3 bottom element 6, is set back from the upper bearing surface 16 of the external frame 11 of the trunk 3 bottom element 6 and forms the notch 18 of the angular indexing member 9.

FIG. 4 shows that, in the vertical direction oriented according to the axis OZ, the membrane 22 delimiting the housing 21 of the audio system 25 is located in an intermediate position between the upper support surface 16 of the external frame 11 of the trunk 3 bottom element 6 and the lower face 17 of the trunk 3 bottom element 6 in accordance with the first aspect. In this case, the membrane 22 delimiting the housing 21 of the audio system 25 is located at a height 30 considered in the vertical direction oriented according to the axis OZ comprised between 40% and 60% of a height 31 of the trunk 3 bottom element 6 considered in the vertical direction oriented according to the axis OZ and at the recess 21.

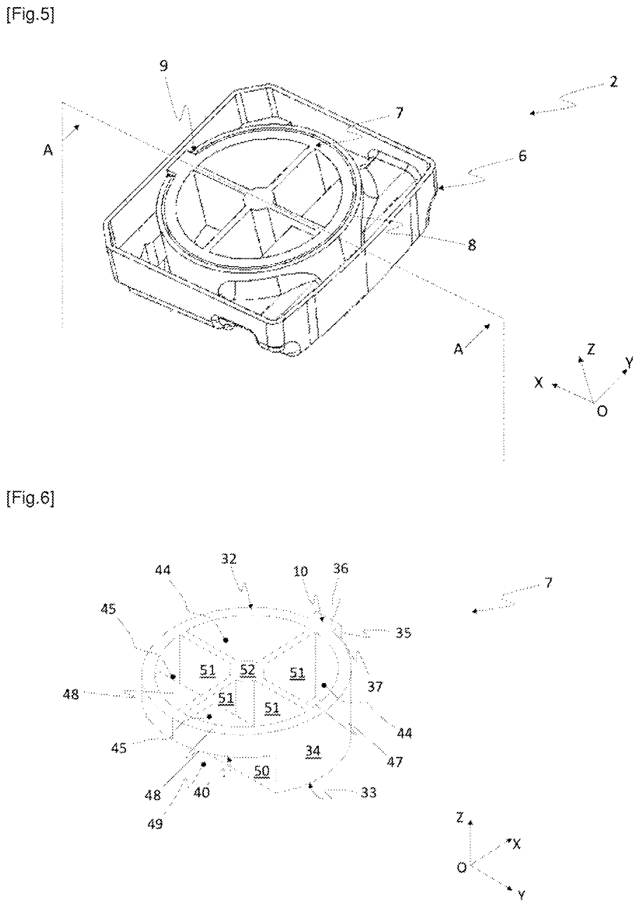

Referring to FIGS. 5, 10 and 13, the trunk 3 arrangement 2 in accordance with the second aspect is illustrated, seen from above in isometric perspective, in three distinct embodiments. The trunk 3 arrangement 2 includes the trunk 3 bottom element 6 according to the first aspect and the closure cap 7. The closure cap 7 is housed in the central opening 8 of the trunk 3 bottom element 6, the closure cap 7 having a general cylindrical conformation with shape and dimension complementary to those of the central opening 8 of the trunk 3 bottom element 6. The trunk 3 arrangement 2 in accordance with the second aspect shown in FIGS. 5, 10 and 13 is shown, respectively, in FIGS. 7, 12 and 15, according to a longitudinal section AA. The longitudinal section AA passes through the angular indexing member 9 of the trunk 3 bottom element 6, as shown in FIGS. 5, 10 and 13.

FIGS. 6, 11 and 14 show the closure cap 7 of the trunk 3 arrangement 2 in accordance with the second aspect. The closure cap 7 comprises an upper bearing wall 32 opposite to a base 33, with respect to the vertical direction, oriented according to the axis OZ. The upper bearing wall 32 of the closure cap 7 and the base 33 of the closure cap 7 are connected by a peripheral wall 34 of the closure cap 7. The peripheral wall 34 of the closure cap 7 is cylindrical and is intended to cooperate with the cylindrical wall 12 of the trunk 3 bottom element by complementary shape engagement.

FIGS. 6, 11 and 14 show that the angular indexing device 10 of the closure cap 7 includes a prismatic support 35 which projects radially from the peripheral wall 34 of the closure cap 7 towards the front of the closure cap 7.

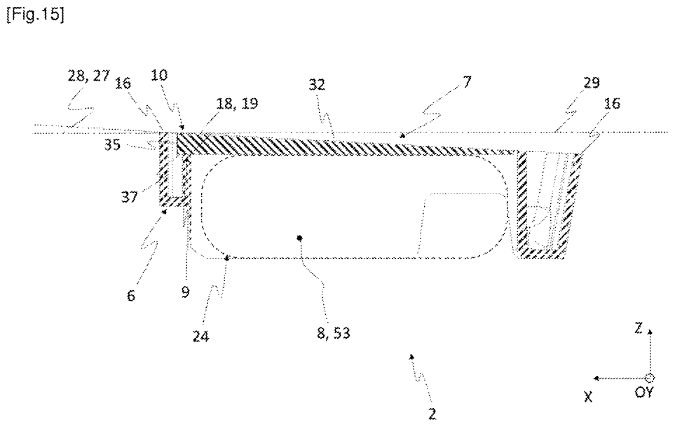

FIGS. 6 and 14 respectively illustrate the closure cap 7 of the first variant and of the third variant of the trunk 3 arrangement 2 in accordance with the second aspect. FIGS. 6 and 14 show a prismatic support 35 of the closure cap 7 including an upper face 36 opposite to a bearing face 37. The upper face 36 of the prismatic support 35 is formed by extension of the upper bearing wall 32 of the closure cap 7. The bearing face 37 of the prismatic support 35 is configured to cooperate with the notch 18 of the trunk 3 bottom element 6 in accordance with the first aspect. FIGS. 7 and 15 show the prismatic support 35 of the angular indexing device 10 of the closure cap 7 engaged in the notch 18 of the trunk 3 bottom element 6, the prismatic support 35 having a complementary shape and complementary dimensions to the notch 18. The bearing face 37 of the prismatic support 35 of the angular indexing device 10 of the closure cap 7 cooperates with the engagement face 19 of the notch 18 forming the angular indexing member 9 of the trunk 3 bottom element 6. FIGS. 7 and 15 show that the prismatic support 35 has a rectangular shaped longitudinal profile. The bearing face 37 of the prismatic support 35 of the angular indexing device 10 of the closure cap 7 bears against the engagement face 19 of the notch 18 forming the angular indexing member 9 of the trunk 3 bottom element 6.

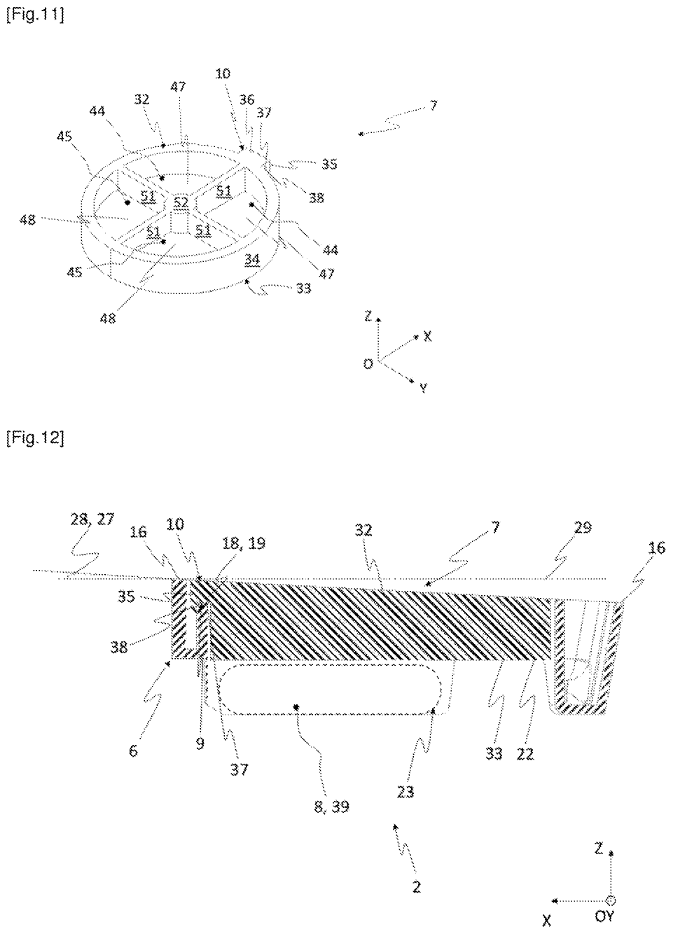

FIG. 11 shows the closure cap 7 of the second variant of the trunk 3 arrangement 2 in accordance with the second aspect. FIG. 11 shows a prismatic support 35 of the closure cap 7 including a groove 38. A bottom of the groove 38 forms the bearing face 37 of the prismatic support 35 of the angular indexing device 10 of the closure cap 7. The upper face 36 is opposite to the bottom of the groove 38 forming the bearing face 37 of the prismatic support 35 of the angular indexing device 10 of the closure cap 7. The groove 38 is formed in the prismatic support 35 opposite to the upper bearing wall 32 of the closure cap 7. The groove 38 of the prismatic support 35 is configured to engage in the notch 18 of the trunk 3 bottom element 6 in accordance with the first aspect so that the bearing face 37 of the prismatic support 35 of the angular indexing device 10 of the closure cap 7 cooperates with the engagement face 19 of the notch 18 of the trunk 3 bottom element 6. FIGS. 10 and 12 show the groove 38 of the prismatic support 35 of the angular indexing device 10 of the closure cap 7 engaged in the notch 18 of the trunk 3 bottom element 6, the groove 38 having a complementary shape and complementary dimensions to the notch 18. FIG. 12 shows that the prismatic support 35 including the groove 38 has an L-like shaped longitudinal profile. The groove bottom 38 forming the bearing face 37 of the prismatic support 35 of the angular indexing device 10 of the closure cap 7 bears against the engagement face 19 of the notch 18 forming the angular indexing member 9 of the trunk 3 bottom element 6. FIG. 12 further shows that the base 33 of the closure cap 7 also bears against the membrane 22. Thus, in the central opening 8 of the trunk 3 bottom element 6, a space 39 for housing a “donut” type spare wheel 23 of the motor vehicle 1 is formed.

FIGS. 7, 12 and 15 show that, in the longitudinal direction, oriented according to the axis OX, the upper bearing wall 32 of the closure cap 7 forms a non-zero angle 28 with respect to the horizontal plane 29, regardless of the variant of the trunk 3 arrangement 2 in accordance with the second aspect. This non-zero angle 28 is equal to the angle 27 formed by the upper bearing surface 16 of the trunk 3 bottom element 6. The cooperation between the angular indexing device 10 of the closure cap 7 and the angular indexing member 9 of the trunk 3 bottom element 6 enables angular indexing of the closure cap 7 in the central opening 8 of the trunk 3 bottom element 6, so that the upper bearing surface 16 of the trunk 3 bottom element 6 and the upper bearing wall 32 of the closure cap 7 are coplanar to support together the trunk 3 floor element 5, not shown.

FIGS. 6 and 7 show that the closure cap 7 of the first variant of the trunk 3 arrangement 2 in accordance with the second aspect comprises an intermediate wall 40 extending substantially horizontally between the upper bearing wall 32 of the closure cap 7 and the base 33 of the closure cap 7. FIG. 7 shows that the intermediate wall 40 of the closure cap 7 is intended to overhang the housing 21 while the base 33 of the closure cap 7 rests on a structure of the motor vehicle 1, not shown.

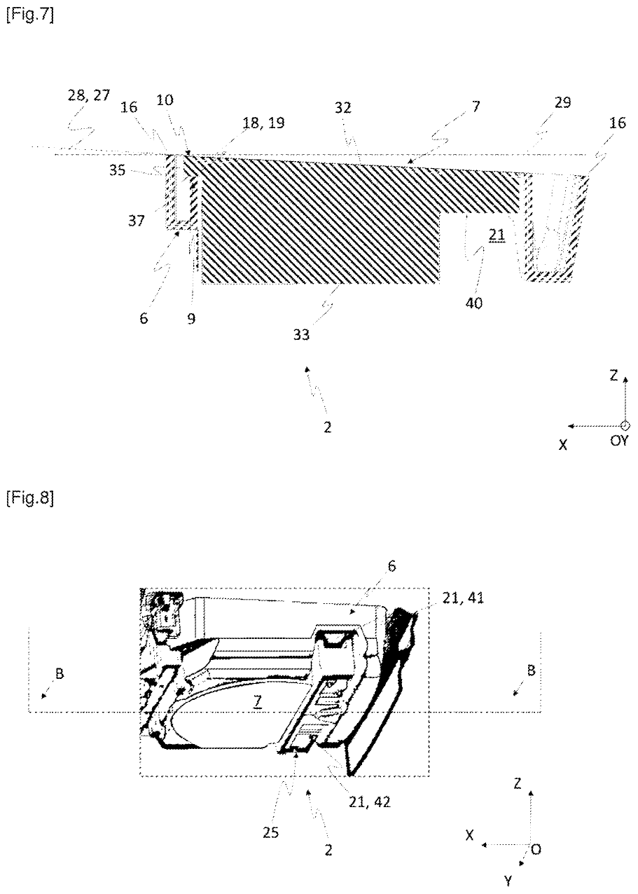

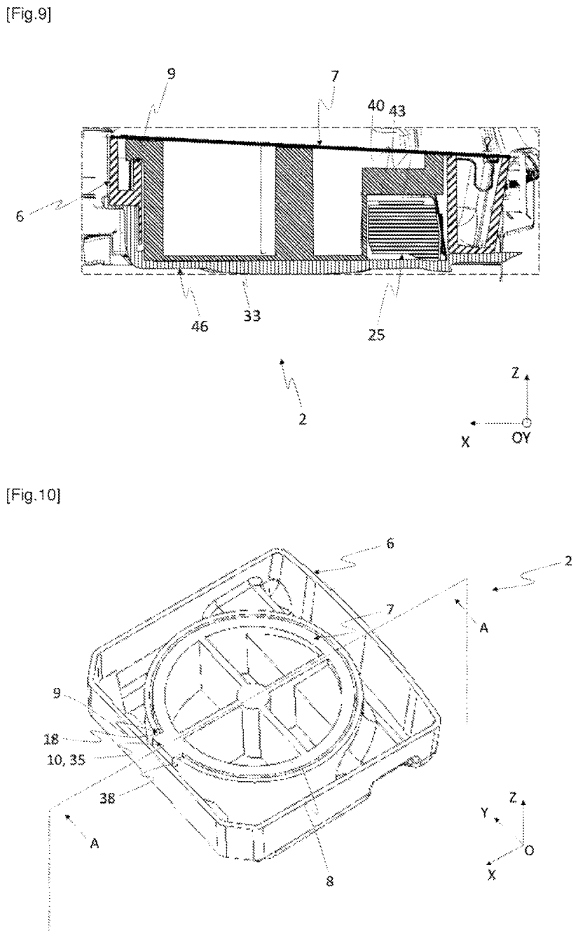

FIGS. 8 and 9 show the first variant of the trunk 3 arrangement 2 in accordance with the second aspect, illustrated in FIG. 7, in a situation. The trunk 3 arrangement 2 in accordance with the second aspect shown in FIG. 9 corresponds to a longitudinal section BB visible in FIG. 8, passing through the angular indexing member 9 of the trunk 3 bottom element 6, not visible in FIG. 8.

FIGS. 8 and 9 illustrate the audio system 25 integrated into the trunk 3 bottom element 6 in accordance with the first aspect, under the closure cap 7. FIG. 8 shows that the audio system 25 extends transversely into the housing 21 of the trunk 3 bottom element 6, from a first transverse end 41 of the housing 21 to a second transverse end 42 of the housing 21 opposite to the first transverse end 41 of the housing 21. FIG. 9 shows that the intermediate wall 40 of the closure cap 7 is separated from the audio system 25 by a gap 43, the closure cap 7 bearing against a structure 46 of the motor vehicle 1 at the base 33 of the closure cap 7.

FIG. 6 shows that the closure cap 7 of the first variant of the trunk 3 arrangement 2 in accordance with the second aspect comprises two front upper chambers 44 and two rear upper chambers 45. The two upper chambers 45 are comprised between the upper bearing wall 32 of the closure cap 7 and the intermediate wall 40 of the closure cap 7. The two front upper chambers 44 are comprised between the upper bearing wall 32 of the closure cap 7 and the base 33 of the closure cap 7. The two front upper chambers 44 and the two rear upper chambers 45 are open on the upper bearing wall 32 of the closure cap 7 and comprise a bottom 47, 48. The two front upper chambers 44 and the two rear upper chambers 45 form an additional storage space in the closure cap 7. The bottom 48 of the upper rear chambers 45 is larger than the bottom 47 of the front upper chambers 44, with respect to the axis OZ. Under the two rear upper chambers 45, between the intermediate wall 40 and the base 33 of the closure cap 7, the closure cap 7 comprises a recess 49 intended to overhang the housing 21. The recess 49 is delimited by the intermediate wall 40 of the closure cap 7 and a rear face 50 of the closure cap 7, the rear face 50 extending perpendicularly to the intermediate wall 40 of the closure cap 7 and from said intermediate wall 40 to the base 33 of the closure cap 7. The rear face 50 of the closure cap 7 is delimited by the intermediate wall 40 of the closure cap 7, the base 33 of the closure cap 7 and the peripheral wall 34 of the closure cap 7.

FIG. 11 shows that the closure cap 7 of the second variant of the trunk 3 arrangement 2 in accordance with the second aspect comprises two front upper chambers 44 and two rear upper chambers 45. The two front upper chambers 44 and the two rear upper chambers 45 are all comprised between the upper bearing wall 32 of the closure cap 7 and the base 33 of the closure cap 7. The two front upper chambers 44 and the two rear upper chambers 45 are open on the upper bearing wall 32 of the closure cap 7 and comprise a bottom 47, 48. The two front upper chambers 44 and the two rear upper chambers 45 form an additional storage space in the closure cap 7. The bottoms 47 of the front upper chambers 44 and the bottoms 48 of the rear upper chambers 45 are coplanar and extend substantially horizontally.

FIGS. 6 and 11 show that the front upper chambers 44 and the rear upper chambers 45 are separated from one another by partitions 51 for separating the chambers 44, 45. The partitions 51 extend radially from the peripheral wall 34 of the closure cap 7 towards a vertical central cylinder 52 of the closure cap 7. The partitions 51 and the peripheral wall 34 of the closure cap 7 delimit the upper bearing wall 32 of the closure cap 7.

FIG. 14 shows that the closure cap 7 of the third variant of the trunk 3 arrangement 2 in accordance with the second aspect comprises the upper bearing wall 32 formed by a solid surface. The upper bearing wall 32 of the closure cap 7 extending over a solid surface is delimited by the peripheral wall 34 of the closure cap 7. FIG. 15 shows that such a closure cap 7 allows the central opening 8 to be closed by clearing a space 53 for accommodating a “full-size” type spare wheel 24 of the motor vehicle 1.

In summary, the disclosed devices relate to a trunk 3 bottom element 6. The trunk 3 bottom element 6 includes an external frame 11 laterally and longitudinally delimiting the trunk 3 bottom element 6, a central opening 8 delimited by a cylindrical wall 12 and an angular indexing member 9 configured to enable angular indexing of a closure cap 7 of the central opening 8, with respect to the vertical direction of the trunk 3 bottom element 6. In the trunk 3 bottom element 6, the external frame 11 has in a vertical direction an upper bearing surface 16 intended to receive a trunk 3 floor element 5. The central opening 8 of the trunk 3 bottom element 6 is configured to alternately house a spare wheel 23, 24 of the motor vehicle 1 of the “donut” type and of the “full-size” type.

Of course, the present description is not limited to the examples that have just been described and numerous modifications could be made to these examples without departing from the. In particular, the different features, shapes, variants and embodiments could be associated together according to various combinations to the extent that they are not incompatible or exclusive of one another. In particular, all of the previously-described variants and embodiments may be combined together.

1. A motor vehicle trunk bottom element, the trunk bottom element including:
an external frame laterally and longitudinally delimiting the trunk bottom element, the external frame having in a vertical direction an upper bearing surface intended to receive a trunk floor element;
a central opening delimited by a cylindrical wall, the central opening being configured to house therein a spare wheel of the motor vehicle;
wherein the trunk bottom element includes an angular indexing member configured to enable angular indexing of a closure cap of the central opening, with respect to the vertical direction of the trunk bottom element.

2. The trunk bottom element according to claim 1, wherein the angular indexing member is in the form of a notch formed on the cylindrical wall.

3. The trunk bottom element according to claim 1, wherein, at the angular indexing member, the cylindrical wall is located radially at a distance from the external frame, with respect to the vertical direction, so that the trunk bottom element includes a peripheral recess at the central opening delimited radially by the cylindrical wall and by the external frame.

4. The trunk bottom element according to claim 1, wherein the trunk bottom element includes a housing intended to house an audio system, the housing being formed between a lower face of the trunk bottom element and the upper bearing surface, the housing being delimited in the vertical direction by a membrane.

5. The trunk bottom element according to claim 4, wherein the housing is in the form of an opening passing throughout the trunk bottom element in the lateral direction.

6. The trunk bottom element according to claim 4, wherein, in the vertical direction, the membrane is located at a height comprised between 30% and 70% of a height of the trunk bottom element considered in the vertical direction and at the housing.

7. A trunk arrangement for a motor vehicle, the trunk arrangement including:
a trunk bottom element according to claim 1;
a closure cap housed in the central opening of the trunk bottom element, the closure cap including an angular indexing device collaborating with the angular indexing member of the trunk bottom element by complementary shape cooperation.

8. The trunk arrangement according to claim 7, wherein the closure cap has a cylindrical general conformation with shape and dimension complementary to those of the central opening of the trunk bottom element, the angular indexing device including a prismatic support which projects radially with respect to the cylindrical general conformation.

9. The trunk arrangement according to claim 8, wherein the angular indexing member is in the form of a notch formed on the cylindrical wall, and wherein the prismatic support includes a groove configured to enable engagement of the notch of the trunk bottom element.

10. A motor vehicle including a trunk arrangement according to claim 1.
